(19) United States
(12) Patent Application Publication
(10) Pub. No.: US 2021/0235829 A1
(43) Pub. Date: Aug. 5, 2021

(54) WALLET CARD RETRIEVAL TAB

(71) Applicant: Andrea Dawson, Pasadena, CA (US)

(72) Inventor: Andrea Dawson, Pasadena, CA (US)

(21) Appl. No.: 16/777,577

(22) Filed: Jan. 30, 2020

(51) Int. Cl. A45C 11/18; A45C 1/06; B42F 21/04; G09F 3/10

(52) U.S. Cl. CPC A45C 11/182; A45C 1/06; A45C 2001/065; G09F 3/10; B42F 21/04

(57) ABSTRACT

Embodiments of a wallet card retrieval device (tab) for retrieval of a wallet card from a wallet slot is disclosed. According to one embodiment, a retrieval device includes a bendable membrane having a first and a second end, a first area of non-permanent adhesive on the first end of the membrane, and a second area of non-permanent adhesive on the second end of the membrane, where the membrane wraps around a wallet card for the first area to adhere to a first side of the wallet card and the second area to adhere to a second side opposite to the first side of the wallet card.

### FIELD

The disclosed embodiments relate generally to retrieval tabs and in particular, but not exclusively, to retrieval tabs for wallet cards.

### BACKGROUND

Wallets are small flat cases that can be used to carry small personal items such as a credit card, cash, transit passes, etc. A leather wallet typically is durable and long-lasting. A typically wallet has multiple card slots to hold multiple wallet cards. The card slots can be horizontal or vertical slots for the wallet cards to be inserted horizontally or vertically into the horizontal or vertical slots, respectively.

Once a wallet card is inserted into a wallet slot, it may be difficult to remove the wallet card from the wallet slot if the wallet card tightly fits the wallet slot, especially for an individual with acrylic nails. Sometimes the wallet card is caught in a wallet groove and the retrieval may cause an acrylic nail to break. A wallet card can include a credit card, a debit card, an identification card, a transit pass, a public transit card, a card key, and/or a business card.

### SUMMARY

Embodiments of a wallet card retrieval device (tab) for retrieval of a wallet card from a wallet slot is disclosed. According to one aspect, a retrieval device includes a bendable membrane having a first and a second end, a first area of non-permanent adhesive on the first end of the membrane, and a second area of non-permanent adhesive on the second end of the membrane, where the membrane wraps around a wallet card for the first area to adhere to a first side of the wallet card and the second area to adhere to a second side opposite to the first side of the wallet card.

For one embodiment, the bendable membrane includes a plastic membrane. For one embodiment, the bendable membrane is of a camouflage color. For one embodiment, the bendable membrane is of a uniform color.

For one embodiment, the membrane wraps around the wallet card to form a loop and the loop is large enough for a finger or a thumb to fit through the loop. For one embodiment, the membrane is a clear or translucent.

According to a second aspect, a wallet card has a wallet card retrieval device adhered to the wallet card. The wallet card retrieval device includes a bendable membrane having a first and a second end, a first area of non-permanent adhesive on the first end of the membrane, and a second area of non-permanent adhesive on the second end of the membrane, where the membrane wraps around a wallet card for the first area to adhere to a first side of the wallet card and the second area to adhere to a second side opposite to the first side of the wallet card.

For one embodiment, the bendable membrane includes a plastic membrane. For one embodiment, the bendable membrane is of a camouflage color. For one embodiment, the bendable membrane is of a uniform color.

For one embodiment, the membrane wraps around the wallet card to form a loop and the loop is large enough for a finger or a thumb to fit through the loop. For one embodiment, the membrane is a clear or translucent.

According to a third aspect, a method to retrieve a wallet card from a wallet slot of a wallet is disclosed. The method includes inserting a finger or a thumb into a loop formed by a bendable membrane of a wallet card retrieval device, where the wallet card retrieval device includes the bendable membrane having a first and a second end, a first area of non-permanent adhesive on the first end of the membrane, and a second area of non-permanent adhesive on the second end of the membrane, where the membrane wraps around the wallet card for the first area to adhere to a first side of the wallet card and the second area to adhere to a second side opposite to the first side of the wallet card. The method includes pulling out the wallet card from a wallet slot of a wallet by applying a pulling force to the loop by the finger or the thumb.

For one embodiment, the bendable membrane includes a plastic membrane. For one embodiment, the bendable membrane is of a camouflage color. For one embodiment, the bendable membrane is of a uniform color.

### BRIEF DESCRIPTION OF THE DRAWINGS

The appended drawings illustrate examples and, therefore, are exemplary embodiments, and not to be considered limiting in scope.

FIG. 1 is a block diagram of a wallet card retrieval device according to one embodiment;

FIG. 2 is a block diagram of a wallet card retrieval device according to another embodiment;

FIG. 3 is a block diagram of a wallet card retrieval device according to another embodiment;

FIG. 4A is a block diagram of a wallet card retrieval device adhered to a side of a wallet card according to one embodiment;

FIG. 4B is a block diagram of a wallet card retrieval device adhered to a top portion of a wallet card according to one embodiment; and

FIG. 5 is a side view of the wallet card according to one embodiment.

### DETAILED DESCRIPTION

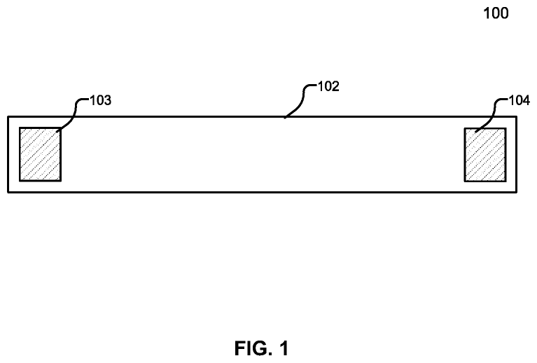

FIG. 1 is a block diagram of a wallet card retrieval device according to one embodiment. Referring to FIG. 1, wallet card retrieval device (e.g., tab) 100 includes, but is not limited to, a body 102 and adhesive regions 103-104. The body 102 can include a bendable membrane in any shape. The bendable membrane can be a plastic polymer membrane. For one embodiment, the plastic polymer is a biodegradable material. For one embodiment, the bendable membrane can include a uniform color or a camouflage color. The colored portions can be portions of any shape and size. The bendable membrane can include drawings/printings of a stylish imagery or animal prints. For one embodiment, the bendable membrane is a rectangular membrane.

The adhesive regions 103-104 can include a strip of adhesive that can adhere the wallet card retrieval device 100 to a wallet card. The adhesive may be non-permanent adhesive, including any types of adhesives, such as, glue, water-based glue, glue that is water resistance, gel, wax, etc. The adhesive may or may not be sticky.

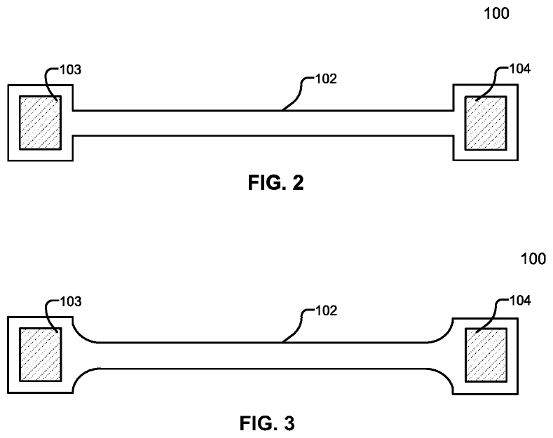

FIG. 2 is a block diagram of a wallet card retrieval device according to another embodiment. Referring to FIG. 2, body 102 can be recessed in a middle portion to reduce the material required to manufacture wallet card retrieval device 100. Here, the middle portion of body 102 should be sturdy enough to withstand a pulling force to retrieve a wallet card when the wallet card retrieval device is adhered to the wallet card. For one embodiment, the recessed portion is a straight cutoff. In another embodiment, the recessed portion may have a gradual taper to reduce a chance of torn for the body 102 as shown in FIG. 3 according to another embodiment.

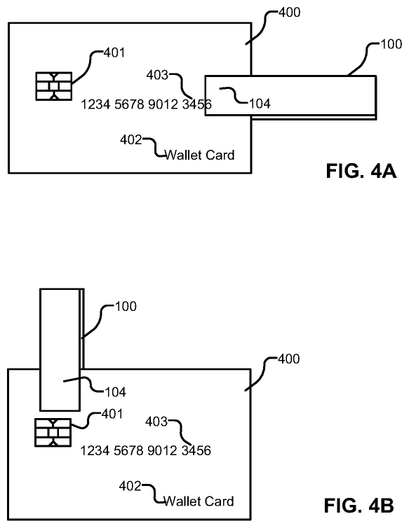

FIG. 4A is a block diagram of a wallet card retrieval device adhered to a side of a wallet card according to one embodiment. The wallet card 400 may be a credit card, a debit card, an identification card, a transit pass, a public transit card, a card key, and/or a business card, etc. The wallet card retrieval device 100 can be adhered to a side of wallet card 400. For one embodiment, the wallet card is a credit card and the wallet card retrieval device 100 is adhered to a side away from a chip 401 of the wallet card. In another embodiment, the wallet card retrieval device 100 is adhered to a side but does not cover a writing 402 of the wallet card. In another embodiment, the wallet card retrieval device 100 has end portions 104 that are transparent or translucent and the end portions 104 are adhered to the wallet card 100 over writing 403. Here, a user would be able to read writing 403 through the end portions 104 because the end portions 104 are translucent or transparent. In one embodiment, a user can peel off an end portion 104 of the wallet card retrieval device 100 from one side of the wallet card 400 and re-adhere the end portion 104 to the same or another side of the wallet 400. In another embodiment, wallet card retrieval device 100 is adhered to a top or a bottom side of wallet card 400. FIG. 4B is a block diagram of a wallet card retrieval device adhered to a top portion of a wallet card according to one embodiment.

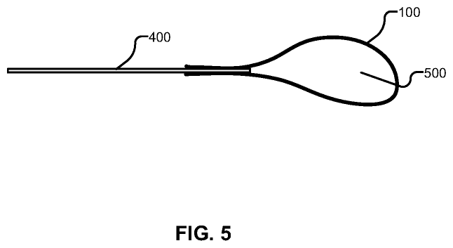

FIG. 5 is a side view of the wallet card according to one embodiment. Referring to FIG. 5, bendable membrane body 102 of wallet card retrieval device 100 forms a loop 500 when the wallet card retrieval device 100 is adhered to a wallet card 400. The wallet card 400 and/or a portion of the wallet card retrieval device 100 can be stored within a wallet slot of a wallet. A user can insert a finger or a thumb in loop 500 and apply a pulling force to loop 500 to retrieve the wallet card 400 from a slot of a wallet. This is useful when the user has fingers/thumb with acrylic nails to prevent the acrylic nail from chipping when a user tries to retrieve a wallet card 400 from a wallet.

The previous description of the disclosed embodiments is provided to enable one to make or use the methods, device or article of the present disclosure. Various modifications to these embodiments will be readily apparent, and the generic principles defined herein may be applied to other embodiments without departing from the spirit or scope of the disclosure. Thus, the present disclosure is not intended to be limited to the embodiments shown herein but is to be accorded the widest scope consistent with the principles and novel features disclosed herein.

What is claimed is:

1. A wallet card retrieval device, comprising:
a bendable membrane having a first and a second end;
a first area of non-permanent adhesive on the first end of the membrane; and
a second area of non-permanent adhesive on the second end of the membrane, wherein the membrane wraps around a wallet card for the first area to adhere to a first side of the wallet card and the second area to adhere to a second side opposite to the first side of the wallet card.

2. The wallet card retrieval device of claim 1, wherein the bendable membrane includes a plastic membrane.

3. The wallet card retrieval device of claim 1, wherein the bendable membrane is of a camouflage color.

4. The wallet card retrieval device of claim 1, wherein the bendable membrane is of a uniform color.

5. The wallet card retrieval device of claim 1, wherein the membrane wraps around the wallet card to form a loop and the loop is large enough for a finger or a thumb to fit through the loop.

6. The wallet card retrieval device of claim 1, wherein the membrane is a clear or translucent.

7. A wallet card having a wallet card retrieval device adhered to the wallet card, wherein the wallet card retrieval device comprises:
a bendable membrane having a first and a second end;
a first area of non-permanent adhesive on the first end of the membrane; and
a second area of non-permanent adhesive on the second end of the membrane, wherein the membrane wraps around the wallet card for the first area to adhere to a first side of the wallet card and the second area to adhere to a second side opposite to the first side of the wallet card.

8. The wallet card of claim 7, wherein the bendable membrane includes a plastic membrane.

9. The wallet card of claim 7, wherein the bendable membrane is of a camouflage color.

10. The wallet card of claim 7, wherein the bendable membrane is of a uniform color.

11. The wallet card of claim 7, wherein the membrane wraps around the wallet card to form a loop and the loop is large enough for a finger or a thumb to fit through the loop.

12. The wallet card of claim 7, wherein the membrane is a clear or translucent.

13. A method to retrieve a wallet card from a wallet slot of a wallet, comprising:
inserting a finger or a thumb into a loop formed by a bendable membrane of a wallet card retrieval device, wherein the wallet card retrieval device comprises:
the bendable membrane having a first and a second end;
a first area of non-permanent adhesive on the first end of the membrane; and
a second area of non-permanent adhesive on the second end of the membrane, wherein the membrane wraps around the wallet card for the first area to adhere to a first side of the wallet card and the second area to adhere to a second side opposite to the first side of the wallet card; and
pulling out the wallet card from a wallet slot of a wallet by applying a pulling force to the loop by the finger or the thumb.

14. The method of claim 13, wherein the bendable membrane includes a plastic membrane.

15. The method of claim 13, wherein the bendable membrane is of a camouflage color.

16. The method of claim 13, wherein the bendable membrane is of a uniform color.

17. The method of claim 13, wherein the membrane wraps around the wallet card to form a loop and the loop is large enough for a finger or a thumb to fit through the loop.

18. The method of claim 13, wherein the membrane is a clear or translucent.
